(19) United States
(12) Patent Application Publication
(10) Pub. No.: US 2004/0161556 A1
(43) Pub. Date: Aug. 19, 2004

(54) Ink-jet recording sheet

(75) Inventor: Toyoki Nishijima, Tokyo (JP)

Correspondence Address: Finnegan, Henderson, Farabow,, Garrett & Dunner, L.L.P., 1300 I Street, N.W., Washington, DC, 20005-3315, US

(73) Assignee: KONICA MINOLTA HOLDINGS, INC.

(21) Appl. No.: 10/776,200

(22) Filed: Feb. 12, 2004

(30) Foreign Application Priority Data
Feb. 17, 2003 (JP) JP2003-038033

(51) Int. Cl. B32B 3/00

(52) U.S. Cl. 428/32.1

(57) ABSTRACT

An ink-jet recording sheet including a support having thereon a porous ink receptive layer containing an oil-soluble compound dispersed with at least two nonionic surface active agents differing in HBL value.

### TECHNICAL FIELD

The present invention relates to an ink-jet recording sheet, and in more detail to an ink-jet recording sheet which results in excellent dispersion stability of oil-soluble compounds, and exhibits excellent resistance to oxidizing gas, bleeding, non-uniformity, and cracking.

### BACKGROUND

In recent years, ink-jet recording materials have increasingly been improved to result in enhanced image quality, which is approaching conventional photographic quality. Specifically, in order to achieve image quality comparable to conventional photographic quality utilizing ink-jet recording, ink-jet recording sheets (hereinafter also referred simply to as recording sheets) themselves have increasingly been improved. Void type recording sheets, which comprise a highly smoothed support having thereon a microscopic porous layer comprised of pigments as well as hydrophilic polymers, exhibit high glossiness, form bright colors, and exhibit excellent ink absorbability as well as excellent drying properties. As a result, the aforesaid sheet is becoming one of the sheets which achieves quality most approaching conventional photographic quality. Particularly, when non-water absorptive supports are employed, it is possible to produce higher quality prints due to no generation of cockling or so-called “wrinkling” after printing as generated on a water absorptive support, so that it is possible to maintain a highly smooth surface.

Ink-jet recording is generally divided into one employing a water based ink comprised of water and water-soluble solvents as an ink solvent, and the other employing a non-water based ink comprised of oil-soluble solvents. Further, each of these is divided into a type employing dyes as a colorant and a type employing pigments. In order to form high quality recording images, it is necessary to use special sheets suitable for each type. With regard to ink, water based inks which result in less load to the environment and safety have come into the mainstream. Of water based inks, pigment inks result in high image durability, while glossiness tends to vary imagewise, whereby prints of conventional photographic quality tend not to be produced. On the other hand, when a water-soluble dye ink is employed, it is possible to produce color prints which exhibit high image clarity as well as uniform surface glossiness, comparable to conventional photographic quality.

The aforesaid water-soluble dyes enable formation of high quality images. However, there may occur problems in which storage stability is not sufficient compared to pigments in such a manner that fading due to sun light or ambient room light, and oxidizing gases such as ozone, which are present in ambient air, is pronounced. Specifically, void type recording sheets provided with a microscopic porous layer tend to be affected by oxidizing gases due to an increase in the contact area of dyes with air in the room, for which improvement is sought.

In order to minimize such degradation during storage, heretofore, many proposals have been presented in which various kinds of antioxidants are incorporated as an anti-discoloring agent. For example, Japanese Patent Publication Open to Public Inspection (hereinafter referred to as JP-A) Nos. 57-87989, 57-74192, and 60-72785 describe ink-jet recording sheets which comprise various compounds as an antioxidant; JP-A Nos. 57-74193 and 2000-158802 describe ink-jet recording sheets into which UV absorbers are incorporated; JP-A Nos. 61-154989 and 2002-274016 describe incorporation of hydrazides; JP-A No. 61-146591 describes incorporation of hindered amine based antioxidants; JP-A No. 61-177279 describes incorporation of nitrogen containing heterocyclic mercapto based compounds; JP-A Nos. 1-115677 and 1-35479 describe incorporation of thioether based antioxidants; JP-A No. 1-36480 describes incorporation of specifically structured hindered phenol based antioxidants; JP-A No. 3-13376 describes incorporation of combination of hindered phenol based antioxidants with hindered amine based antioxidants; JP-A Nos. 7-195824 and 8-150773 describe incorporation of ascorbic acids; JP-A No. 7-149037 describes incorporation of thiocyanates and the like; JP-A No. 7-314882 describes incorporation of thiourea derivatives and the like; JP-A Nos. 7-276790 and 8-108617 describe incorporation of saccharides; JP-A No. 8-118791 describes incorporation of phosphoric acid based antioxidants; JP-A No. 8-300807 describes incorporation of nitrites, sulphites, thiosulfates, and the like; JP-A No. 9-267544 describes hydroxylamine derivatives; and JP-A No. 2002-283710 describes incorporation of tocophenol derivatives.

However, with regard to ink-jet recording sheets comprising microscopic voids, it is difficult to state that the technical range proposed as above results in sufficient desired effects. Further, problems occur in which when the aforesaid anti-discoloring agents are employed in a large amount to sufficiently result in anti-discoloring effects, ink absorbability of the porous layer is degraded.

Many of the aforesaid antioxidants are generally oil-soluble compounds. When they are incorporated into an ink receptive layer liquid coating composition, one of the following methods is usually employed; (1) a method in which they are dissolved in oil-soluble solvents and incorporated into a liquid coating composition, (2) a method (solid dispersion) in which they are dispersed into binders in the form of minute particles, and (3) a method in which they are incorporated into a liquid coating composition in the form of an O/W type emulsion. Specifically, listed as a method to prepare the O/W type emulsion is an oil protecting method described, for example, in JP-A No. 4-125559. In JP-A Nos. 2000-158802, 2002-274016, and 2002-283710, gelatin is used as a hydrophilic polymer. In the case of a porous ink receptive layer, it is known that when swellable components such as gelatin are incorporated, ink absorbability is degraded. Currently, no methods have been found are to stably incorporate oil-soluble substances into a liquid coating composition without degrading ink absorbability. Further, when dissolved in oil-soluble solvents or dispersed in the form of minute particles, problems tend to occur in which recording sheets result in degradation of the coating layer quality such as formation of cracks due to effects of solvents, and in addition high density is not obtained due to a decrease in transparency of the coating layer.

On the other hand, methods in which nonionic surface active agents having the specified HLB value are incorporated into the ink receptive layer are proposed, for example, in JP-A Nos. 60-171190, 62-144986, 7-137434, 9-99631, 9-226231, and 10-278409. However, in any of these patents, the aforesaid surface active agents are incorporated into an ink receptive layer liquid coating composition to mainly improve ink absorbability as well as printing quality and coatability, and no description is made with regard to the method to stably emulsify-disperse oil-soluble compounds as well as to meet invention concept.

Further, when a water-soluble dye ink is employed, problems occur in which bleeding results due to its high hydrophilicity, and water resistance is also degraded. Namely, when recorded images are stored at high humidity over an extended period of time or water droplets adhere to print surface, dyes tend to result in bleeding. In order to overcome this drawback, it is a general practice that dye fixing substances such as cationic substances are incorporated into a porous layer. For example, a method is preferably employed in which cationic polymers are allowed to bond to anionic ink dyes to result in secure immobilization. Listed as such cationic polymers are polymers having a quaternary ammonium group, which are described, for example, in “Ink-jet Printer Gijutsu to Zairyo (Technology and Materials of Ink-jet Printers), (published by CMC Co., Ltd., July 1998) and references cited in paragraph number [0008] of JP-A No. 9-193532. Further, a method is also proposed in which water-soluble multivalent metal ions are previously incorporated into ink-jet recording sheets, so that dyes are subjected to coagulation and adhesion to result in immobilization during ink-jet recording. It is to be noted that cationic polymers and multivalent metal ions result in enhancement of bleeding resistance as well as water resistance. However, even though the aforesaid anti-discoloring agents are added, it is difficult occasionally to efficiently exhibit the desired effects, when their diffusion is low in an ink absorptive layer, due to the fact that dyes are subjected to non-uniform dying in the ink absorptive layer due to bonding of dyes with cationic polymers and multivalent metals.

On the other hand, it has been known that it is possible to use resins, such as butadiene rubber, having an unsaturated bond in the molecule in ink-jet recording sheets. For example, methods (for example, refer to Patent Documents 1-6) are disclosed which use the aforesaid resins as a resin which absorbs mainly oily ink solvents. Further, a method to use the aforesaid resins is disclosed in such a manner that absorbability of water based ink is enhanced by sulfonizing diene based polymers, or hydrogenated ones thereof, to be hydrophilic. However, it has not been known that storage stability is improved by incorporating compounds having an unsaturated bond into a microscopic porous ink absorptive layer.

### Patent Document 1

JP-A No. 2000-177234

### Patent Document 2

JP-A No. 2000-238407

### Patent Document 3

JP-A No. 2001-205929

### Patent Document 4

JP-A No. 11-165460

### Patent Document 5

JP-A No. 11-99742

### Patent Document 6

International Patent Publication Open to Public Inspection, WO 00/41890 Pamphlet

An object of the present invention is to provide an ink-jet recording sheet which exhibits excellent resistance to oxidizing gas, bleeding, non-uniformity, and cracking by incorporating an oil-soluble compound dispersion, which exhibits excellent stability, into an ink receiving layer.

### SUMMARY OF THE INVENTION

The aforesaid object of the present invention is achieved employing the embodiments below.

(1) An ink-jet recording sheet which comprises a porous ink receptive layer incorporating an oil-soluble compound which is dispersed employing at least two nonionic surface active agents which differ in HLB value.

(2) An ink-jet recording sheet which comprises a porous ink receptive layer incorporating an oil-soluble compound which is dispersed employing at least two nonionic surface active agents which differ in HLB value and a hydrophilic polymer.

(3) An ink-jet recording sheet which comprises a porous ink receptive layer incorporating at least a nonionic surface active agent of HLB ≦10, a nonionic surface active agent of HLB >10 and a oil-soluble compound.

(4) The ink-jet recording sheet, described in any one of Items 1-3, wherein said oil soluble compound is a compound which comprises a plurality of non-aromatic unsaturated carbon-carbon bonds in the molecule.

(5) The ink-jet recording sheet, described in Item 4, wherein said compound which comprises a plurality of non-aromatic unsaturated carbon-carbon bond in the molecule is a polymer which is prepared employing a butadiene monomer.

(6) The ink-jet recording sheet, described in any one of Items 1-5, wherein said oil-soluble compound dispersion comprises an antiseptic agent.

(7) The ink-jet recording sheet, described in any one of Items 1-6, wherein said porous ink receptive layer comprises minute inorganic particles and a hydrophilic polymer.

(8) The ink-jet recording sheet, described in any one of Items 1-7, wherein said porous ink receptive layer comprises a cationic polymer.

(9) The ink-jet recording sheet, described in any one of Items 1-8, wherein said porous ink receptive layer comprises a water-soluble multivalent metal compound.

In order to overcome the aforesaid problems, the inventors of the present invention conducted diligent investigations. As a result, it was discovered that it was possible to realize an ink-jet recording sheet which exhibits excellent ink absorbability, results in excellent image clarity, and exhibits no deterioration of layer surface quality such as cracking, and also exhibits excellent storage stability. The aforesaid ink-jet recording sheet comprised a porous ink absorptive layer incorporating oil-soluble compounds which were dispersed employing at least two nonionic surface active agents having different HLB values, or comprised a porous ink absorptive layer incorporating oil-soluble compounds which were dispersed employing at least two nonionic surface active agents having different HLB values and hydrophilic polymers. Namely, the emulsified dispersion according to the present invention is prepared employing at least two nonionic surface active agents having different HLB values, or together with hydrophilic polymers. As a result, is prepared a stable emulsified dispersion at a high concentration of oil-soluble compounds. Consequently, degradation of ink absorbability and degradation of coating layer quality such as cracking are minimized. It is assumed that an O/W type dispersion system is stabilized employing optimal combinations of certain types of oil-soluble nonionic surface active agents (emulsifiers) of HLB ≦10 with water-soluble nonionic surface active agents (emulsifiers) of HLB >10.

Further, in the ink-jet recording sheet of the present invention, by incorporating compounds having a plurality of unsaturated carbon-carbon bonds in the molecule into the porous ink receptive layer, stability of dyes is improved. As a result, discoloration of water based dye ink due to oxidizing gases, especially due to ozone gas, which has particularly been a drawback of the porous ink absorptive layer, is markedly minimized. Reasons for improvement in storage stability are not yet fully understood. However, it is assumed that the unsaturated carbon-carbon bond exhibits appropriate reactivity with ambient oxidizing gases to minimize discoloration of dyes. For example, it is known that rubber based resins are degraded due to the presence of unsaturated bonds as a reactive group under the presence of oxygen, ozone, radicals, and peroxides. In order to minimize such degradation of rubber, employed as antioxidants are hindered phenols, amines, sulfur based compounds, and phosphorous based compounds. As described in the prior art, these antioxidants have been applied to ink-jet recording sheets as an anti-discoloring agent. However, these antioxidants exhibit higher reactivity than that of the unsaturated bond of rubber based resins, which are supposed to exhibit high reactivity. As a result, they are employed as an agent to minimize degradation of resins and are readily affected specially by ambient oxidizing gasses. It is assumed that in void type ink-jet recording sheets having microscopic voids in the ink absorptive layer, it is difficult to obtain continuous desired effects due to their rapid consumption. Unsaturated bonds such as those incorporated into rubber based resins exhibit higher reactivity to oxidizing gases compared to dyes, resulting in anti-coloring effects. However, it is assumed that since they are more stable compared to the aforesaid antioxidants, their effects last longer and exhibit higher anti-discoloring capability.

### DESCRIPTION OF THE PREFERRED EMBODIMENTS

The present invention will now be detailed.

Preferred as oil-soluble compounds according to the present invention are liquefied compounds which include organic compounds which are substantially insoluble in water, plasticizers, water-insoluble or sparingly soluble synthesized polymers. When compounds are solids, it is necessary to liquefy them by dissolving them in high boiling point solvents.

The porous ink receptive layer according to the present invention is characterized in being comprised of oil-soluble compounds which are dispersed employing at least two nonionic surface active agents having different HLB values. In the surface active agents according to the present invention, the balance between the hydrophilic group and the hydrophobic group in the chemical structure, namely the HLB value, is critical. It is preferable that at least two surface active agents having HLB ≦10 and HLB >10 are combined. Nonionic surface active agents having HLB ≦10 are oil-soluble nonionic emulsifiers. For example, polyoxyethylene alkyl ether based surface active agents are preferred. Further, listed as nonionic surface active agents having HLB ≦10 are, for example, Emulgen 103 (HLB 8.1), Emulgen 104P (HLB 9.6), and Emulgen 105 (HLB 9.7) as polyoxyethylene lauryl ether, Emulgen 306P (HLB 9.4) as polyoxyethylene stearyl ether, Emulgen 404 (HLB 8.8) as polyoxyethylene oleyl ether of the Emulgen Series, manufactured by Kao Corp. However, the present invention is not limited thereto. When the HLB is 4 or less, hydrophobicity increases. As a result, repellency spots and cracking due to them tend to occur due to a decrease in compatibility with coating compositions. The HLB value is preferably 5-10, and is more preferably 8-10.

In the same way, listed as nonionic surface active agents having HLB >10 are Emulgen 106 (HLB 10.5), Emulgen 108 (HLB 12.1), Emulgen 109 (HLB 13.6), Emulgen 120 (HLB 15.3), Emulgen 123P (HLB 16.9) as polyoxyethylene lauryl ether, and Emulgen 409P (HLB 12.0), Emulgen 420 (HLB 13.6) and Emulgen 430 (HLB 16.2) as polyoxyethylene oleyl ether. However the present invention is not limited thereto.

When the HLB is at least 17, hydrophilicity increases to affect the surface tension of liquid coating compositions. Therefore, the HLB is preferably 16 or less.

A method to use at least two surface active agents, having different HLB values, is suitably selected based on characteristics of oil-soluble compounds employed as a dispersoid. For example, a nonionic surface active agent having HLB ≦10 is added to an oil phase comprised of oil-soluble compounds, while a nonionic surface active agent having HLB >10 is added to a water phase used as a dispersion medium. Subsequently, both are mixed and then emulsify-dispersed employing mechanical energy such as stirring or kneading.

The added amount of nonionic surface active agents according to the present invention varies depending on properties of oil-soluble compounds as a dispersoid, but is preferably 0.1-5 parts by weight with respect to 100 parts by weight of the dispersoid. It is preferable that the added amount is suitably chosen based on the stability of the dispersion systems.

Further, from the viewpoint of dispersion stability, it is preferable that during dispersion of oil-soluble compounds according to the present invention, hydrophilic polymers are used in a water phase together with nonionic surface active agents exhibiting HLB >10. Hydrophilic polymers are not particularly limited and those known in the prior art may be employed. It is possible to use, for example, gelatin, polyvinylpyrrolidone, polyethylene oxides, polyacrylamide, or vinyl alcohol. Of these, polyvinyl alcohol is particularly preferred.

The added amount of hydrophilic polymers is preferably 1-20 parts by weight with respect to 100 parts by weight of the dispersoid. It is preferable that the added amount is suitably decided based on stability of dispersion systems.

Antiseptic agents employed in the present invention are preferably those which do not break emulsified dispersion systems of oil-soluble compounds. Specific examples include thiazolylbenzimidazole based compounds, chlorophenol based compounds, bromophenol based compounds, thiocyanic acid or isocyanic acid based compounds, acid azide based compounds, diazine or triazine based compounds, thiourea based compounds, quaternary ammonium salts, organic tin or zinc compounds, cyclohexylphenol based compounds, imidazole and benzimidazole based compounds, sulfamide based compounds, and halogen based compounds such as sodium isocyanurate. Of these, isothiazolone based compounds and alkylguanidine compounds are particularly preferred. Specifically listed as isothiazolone based compounds are 2-methyl-4-isothiazoline-3-one and 2-n-octyl-4-isothiazoline-3-one, while listed as alkylguanidine compounds are polyhexamethylenebiguanidine hydrochloric acid salt and dodecylguanidine hydrochloric acid salt. It is preferable that antiseptic agents are added after dispersion. The added amount is preferably in the range of 1×10⁻⁴-1×10⁻² part by weigh with respect to 100 parts by weight of the dispersion.

Compounds according to the present invention, having a plurality of non-aromatic unsaturated carbon-carbon bonds in the molecule, as described in the present invention, refer to compounds which have at least two ethylenic double bonds or acetylenic triple bonds in the molecule. It is assumed that the non-aromatic unsaturated carbon-carbon bond portion relates to enhancement of storage stability of dyes. From the viewpoint of ink absorbability, addition of a large amount of dye stabilizers to an ink-jet recording sheet, comprising a porous ink absorptive layer, is not preferred because voids are sealed resulting in a decrease in void capacity. Consequently, requirements for dye stabilizers are that sufficient dye stabilizing effects are exhibited at a lower addition amount. Further, it is required that added dye stabilizers are stably retained in the porous layer. For example, even though compounds have non-aromatic carbon-carbon bond(s) in the molecule, compounds of relatively low molecular weight such as ethylene or allyl alcohol are not capable of being retained in the porous layer due to their high volatility. In order to decrease volatility, it is required to increase molecular weight or to introduce a high polar substituent. However, it is not preferable to decrease the ratio of unsaturated bonds by simply increasing the molecular weight because a decrease in void volume results. Consequently, it becomes important that the ratio of unsaturated bonds per weight is not decreased while allowing a plurality of non-aromatic unsaturated carbon-carbon bonds and thereby reducing volatility. On the other hand, dyes adhered to a porous layer employing cationic polymers are fixed in a certain range of the porous layer. In an extreme case, occasionally, a portion near the uppermost surface of the porous layer results in dying. In order to effectively enhance the storage stability of fixed dyes in such a state, it is preferable that dye stabilizers are diffusible to a certain degree in the porous layer and continuously exist near the fixed dyes. Namely, the uppermost surface of the porous layer firstly comes into contact with ambient oxidizing gases and the aforesaid dye stabilizers tend to be relatively rapidly consumed. In the case in which dyes are localized near the uppermost surface, when it is possible to allow the dye stabilizers to diffuse somewhat in the porous layer, it is possible to allow the dye stabilizers to diffuse from the relatively deep portion of the porous layer to the uppermost surface in a state which exhibits high dye stabilizing effects, whereby it is possible to achieve higher desired effects. Factors which determine diffusibility of compounds having the non-aromatic unsaturated carbon-carbon bonds in the molecule are not generally decided. However, it is preferable that the molecular weight does not become higher than required. The number average molecular weight of high molecular weight compounds such as polymers is preferably 100,000 or less, and is more preferably 500-10,000. When low molecular weight compounds are employed, the boiling point is preferably at least 200° C. and is more preferably 300° C.

Specific examples of compounds having non-aromatic unsaturated carbon-carbon bond(s) in the molecule include, but are not limited to, resins such as resins prepared by polymerizing butadiene alone or copolymerizing butadiene together with other polymerizable monomers, diallyl phthalate resins, unsaturated polyester resins, furan resins, C5 petroleum resins, terpene resins, cyclopentadiene based resins, polymers prepared by polymerizing monomers having a plurality of polymerizable groups such as diallyl phthalate, triallyloxy-1,3,5-triazinepentaerythrytol tetra(meth)acrylate, Trimethylolpropanetri(meth)acrylatre or divinylbenzene, and unsaturated fatty acids such as linoleic acid, linolenic acid, or arachidonic acid and esters thereof.

Of these, preferred as compounds which exhibit the high ratio of non-aromatic unsaturated carbon-carbon bonds per unit weight are water-insoluble polymers and specifically butadiene polymers are preferably employed. In order to control compatibility with ink solvents and the viscosity of resins, also preferred are polybutadienes which are prepared by modifying the terminal with a hydroxyl group, a glycidyl group, an amino group, or maleic anhydride, or polybutadienes prepared by copolymerizing butadiene with styrene, acrylonitrile, or (meth)acrylic acid esters. Such polybutadienes are readily commercially available under various trade names such as Nisso PB (manufactured by Nippon Soda Co., Ltd.), Nisseki Polybutadiene (manufactured by Nippon Petrochemicals Co., Ltd.), Poly-bd (manufactured by Idemitsu Petrochemical Co., Ltd.), Hycar (manufactured by Ube Industries, Ltd.), Polyoil (Nippon Zeon Co., Ltd.), and JSR RB (manufactured by JSR Co., Ltd.).

The added amount of compounds having non-aromatic unsaturated carbon-carbon bonds in the molecule is not particularly limited, but is preferably in the range of 0.01-3.0 g per m² of the recording sheet. When it is at most 3.0 g, it is possible to minimize sealing of voids of the porous ink receptive layer by the aforesaid compounds. On the hand, when it is at least 0.01 g, it is possible to allow sufficiently exhibiting the effects of the present invention. From this viewpoint, the aforesaid compounds are preferably employed in the range of 0.1-2 g per m² of the recording sheet.

It is preferable that the ink-jet recording sheet of the present invention is prepared in such a manner that a water-soluble liquid coating composition comprising hydrophilic polymers and minute inorganic particles is applied onto a support to form a porous ink receptive layer having voids. The porous layer according to the present invention is comprised mainly of minute inorganic particles and hydrophilic polymers. Listed as minute inorganic particles to form the porous layer may be, for example, white pigments such as precipitated calcium carbonate, calcium carbonate heavy, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatomaceous earth, calcium silicate, magnesium silicate, synthetic non-crystalline silica, colloidal silica, alumina, colloidal alumina, pseudoboehmite, aluminum hydroxide, lithopone, zeolite, or magnesium hydroxide.

In the present invention, from the viewpoint of preparing high quality prints employing ink-jet recording sheets, preferred as minute inorganic particles are silica or alumina, and in addition, alumina, pseudoboehmite, colloidal silica, or minute silica particles synthesized employing a vapor phase method. Of these, particularly preferred are minute silica particles synthesized employing a vapor phase method. The surface of the aforesaid silica particles synthesized employing a vapor phase method may be modified with aluminum. The proportion of aluminum in the vapor phase method silica, of which surface is modified with aluminum, is preferably 0.05-5 percent by weight with respect to the silica.

Any appropriate particle diameter of the aforesaid minute inorganic particles may be employed. However, the average particle diameter is preferably at most 1 μm. When it exceeds 1 μm, glossiness or color forming properties tend to be degraded. Consequently, 200 nm or less is preferred, however 100 nm or less is more preferred. Even though the lower limit of the particle diameter is not particularly specified, from the viewpoint of preparation of minute inorganic particles, the particle diameter is preferably not less than 3 nm, and more preferably not less than 5 nm.

The average diameter of the aforesaid minute inorganic particles is determined as follows. The cross section and surface of the porous layer is observed employing an electron microscope and the diameter of each of 100 randomly selected particles is determined. Subsequently, a simple average (being a number average) is calculated. Herein, each particle diameter is represented by the diameter of a circle which has the same area as that of the projected area of the particle.

The aforesaid minute inorganic particles may exist in the porous layer in the form of primary particles without any modification, or higher order aggregated particles such as secondary particles or higher order particles. However, the aforesaid average particle diameter refers to the diameter of particles which are independently formed in the porous layer, when observed employing an electron microscope.

The content of the aforesaid minute inorganic particles in a water-soluble liquid coating composition is 5-40 percent by weight, and is more preferably 7-30 percent by weight. The aforesaid minute inorganic particles are required to form an ink absorptive layer which exhibits sufficient ink absorbability and minimizes cracks of the layer. The coating weight in the ink absorptive layer is preferably 5-50 g/m², and is more preferably 10-25 g/M².

Hydrophilic polymers incorporated into the porous layer are not particularly limited, and it is possible to list prior art hydrophilic polymers. For example, employed may be gelatin, polyvinylpyrrolidone, polyethylene oxide, polyacrylamide, and polyvinyl alcohol. Of these, polyvinyl alcohol is particularly preferred.

Polyvinyl alcohol exhibits interaction with minute inorganic particles and exhibits especially high holding power for minute inorganic particles. Further, polyvinyl alcohol is a polymer which exhibits relatively small temperature dependence in regard to hygroscopic property. As a result, polyvinyl alcohol is suitably employed to minimize cracking during coating and drying, since it exhibits relatively small shrinkage stress during coating and drying. Polyvinyl alcohol, which is preferably employed in the present invention,—includes common polyvinyl alcohol which is prepared by hydrolyzing polyvinyl acetate and in addition, employed may be modified polyvinyl alcohols such as cation-modified polyvinyl alcohol at the terminal or anion-modified polyvinyl alcohol having an anionic group.

Polyvinyl alcohol of an average degree of polymerization of at least 300, which is prepared by hydrolyzing vinyl acetate, is preferably employed and the aforesaid polyvinyl alcohol of an average degree of polymerization of 1,000-5,000 is more preferably employed. The ratio of saponification of the aforesaid polyvinyl alcohol is preferably 70-100 percent, and is more preferably 80-99.9 percent.

Cation-modified polyvinyl alcohols are ones which have a primary, secondary, or tertiary amino group or a quaternary amino group on the main or side chain of the aforesaid alcohol, which are described, for example, in JP-A No. 61-10483. These are prepared by ketonizing copolymers of ethylenic unsaturated monomers having a cationic group with vinyl acetate.

Listed as ethylenic unsaturated monomers having a cationic group are, for example, trimethyl-(2-acrylamido-2,2-dimethylethyl)ammonium chloride, trimethyl-(3-acrylamido-3,3-dimethylpropyl)ammonium chloride, N-vinylimidazole, N-methylvinylimidazole, N-(3-dimethylaminopropyl)methacrylamide, hydroxyethyltrimethylammonium chloride, and trimethyl-(3-methacrylamidopropyl)ammonium chloride.

The ratio of monomers comprising a cation-modified group of the cation-modified polyvinyl alcohol is customarily 0.1-10 mol percent with respect to vinyl acetate, and is preferably 0.2-5 mol percent.

Listed as anion-modified polyvinyl alcohols are, for example, polyvinyl alcohol having an anionic group, described in JP-A No. 1-206088, copolymers of polyvinyl alcohol with vinyl compounds having water-solubilizing group, described in JP-A Nos. 61-237681 and 63-307979, and modified polyvinyl alcohol having a water-solubilizing group, described in JP-A No. 7-285265.

Further, listed as nonion-modified polyvinyl alcohols are, for example, polyvinyl alcohol derivatives prepared by partially adding a polyalkylene oxide group to polyvinyl alcohol, described in JP-A. No 7-9758 and block copolymers of vinyl compounds having a hydrophobic group with vinyl alcohol, described in JP-A No. 8-25795.

It is possible to simultaneously use at least two polyvinyl alcohols which differ in degree of polymerization and type of modification. Specifically, when polyvinyl alcohol of a degree of polymerization of at least 2,000 is used, it is preferable that the aforesaid polyvinyl alcohol is added to minute inorganic particles in an amount of 0.05 -10 percent by weight or preferably 0.1-5 percent by weight and subsequently, polyvinyl alcohol of a degree of polymerization of at least 2,000 is added to minimize a marked increase in viscosity.

The weight ratio of minute inorganic particles to hydrophilic polymers in a porous layer is preferably 2-20. When the weight ratio is at least twice, a porous layer having a sufficient void ratio is prepared, whereby sufficient void capacity is achieved. As a result, voids are not sealed due to swelling of hydrophilic polymers capable of holding voids, whereby it becomes a factor to maintain a high ink absorption rate. On the other hand, in the case in which the aforesaid ratio is 20 times or less, when the porous layer is coated to result in higher thickness, cracking tends not to result. The particularly preferred ratio of minute inorganic particles to the hydrophilic polymers is 2.5-12, and is most preferably 3-10.

For the purpose of minimizing bleeding of images during storage, cationic polymers are preferably employed in the ink-jet recording sheet of the present invention.

Examples of cationic polymers include polyethyleneimine, polyallylamine, polyvinylamine, dicyandiamidopolyalkylenepolyamine condensation products, polyalkylenepolyaminedicyandiamidoammoniun salt condensation products, dicyandiamidoformalin condensation products, epichlorohydrine-dialkylamine addition polymers, diallyldimethylammonium chloride polymers, diallyldimethylammonium chloride-SO₂ copolymers, polyvinylimidazole, vinylpyrrolidone-vinylimidazole copolymers, polyvinylpyridine, polyamidine, chitosan, cationized starch, vinylbenzyltrimethylammonium chloride polymers, (2-methacroyloxyethyl)trimethylammonium chloride polymers, and dimethylaminoethyl methacrylate polymers.

Examples also include cationic polymers, described in Kagaku Kogyo Jiho (Chemical Industry News, Aug. 15 and 26, 1998, as well as polymer dye fixing agents described in “Kobunshi Yakuzai Nyumon (Introduction to Polymer Agents)”, published by Sanyo Chemical Industries, Ltd.

Further, in order to improve water resistance as well as moisture resistance of images, it is preferable that multivalent ions are incorporated into the ink-jet recording sheet of the present invention. Multivalent metal ions are not particularly limited as long as they are divalent or higher valent metal ions. Listed as preferred multivalent metal ions are those of aluminum, zirconium, and titanium.

These multivalent metal ions may be incorporated into the ink absorptive layer in the form of water-soluble or water-insoluble salts. Listed as specific examples of salts containing aluminum ions may be aluminum fluoride, hexafluoroaluminic acid (e.g. potassium salts), aluminum chloride, basic aluminum chloride (e.g. polyaluminum chloride), tetrachloroaluminates (e.g. sodium salts), aluminum bromide, tetrabromoaluminates (e.g., potassium salts), aluminum iodide, aluminates (e.g., sodium salts, potassium salts, and calcium salts), aluminum chlorate, aluminum perchlorate, aluminum thiocyanate, aluminum sulfate, basic aluminum sulfate, aluminum potassium sulfate (alum), aluminum ammonium sulfate (ammonium alum), aluminum sodium sulfate, aluminum phosphate, aluminum nitrate, aluminum hydrogenphosphate, aluminum carbonate, aluminum polysulfate silicate, aluminum formate, aluminum acetate, aluminum lactate, aluminum oxalate, aluminum isopropyrate, aluminum butyrate, ethyl acetate aluminum diisopropyrate, aluminum tris(acetyl acetate), aluminum tris(ethyl acetoacetate), and aluminum monoacetylacetonatebis(ethyl acetoacetate).

Of these, preferred are aluminum chloride, basic aluminum chloride, aluminum sulfate, basic aluminum sulfate, and basic aluminum sulfate silicate. Further, of these, most preferred are basic aluminum chloride and basic aluminum sulfate.

Further, listed as specific examples of salts containing zirconium ions are zirconium difluoride, zirconium trifluoride, zirconium tetrafluoride, hexafluorozirconates (e.g., potassium salts), heptafluorozirconates (e.g., sodium salts, potassium salts, and ammonium salts), octafluorozirconates (e.g., lithium salts), zirconium fluoride oxide, zirconium dichloride, zirconium trichloride, zirconium tetrachloride, hexachlorozirconates (e.g., sodium salts and potassium salts), zirconium acid chloride (zirconyl chloride), zirconium dibromide, zirconium tribromine, zirconium tetrabromide, zirconium bromide oxide, zirconium triiodide, zirconium tetraiodide, zirconium peroxide, zirconium hydroxide, zirconium sulfide, zirconium sulfate, zirconium p-toluenesulfonate, zirconyl sulfate, sodium zirconyl sulfate, acidic zirconyl sulfate trihydrate, potassium zirconyl sulfate, zirconyl selenate, zirconium nitrate, zirconyl nitrate, zirconium phosphate, zirconyl carbonate, zirconyl carbonate ammonium, zirconium acetate, zirconyl acetate, zirconyl acetate ammonium, zirconyl lactate, zirconyl citrate, zirconyl stearate, zirconyl phosphate, zirconium oxalate, zirconium isopropionate, zirconium butyrate, zirconium acetylacetonate, acetylacetone zirconium butyrate, stearic acid zirconium butyrate, zirconium acetate, bis(acetylacetonato)dichlorozirconium, and tris(acetylacetonato)chlorozirconium.

Of these, from the viewpoint of markedly achieving minimized bleeding effects after printing, which is the purpose of the present invention, preferred are zirconyl carbonate, zirconyl carbonate ammonium, zirconyl acetate, zirconyl nitrate, zirconyl chloride, zirconyl lactate, and zirconyl citrate. Further, of these, particularly preferred are zirconyl carbonate ammonium, zirconyl chloride, and zirconyl acetate.

These multivalent metal ions may be employed individually or in combinations of at least two different types. Compounds comprising multivalent metal ions may be incorporated into ink receptive layer forming liquid coating compositions, or after coating a porous layer, specifically after coating and drying a porous layer, the aforesaid multivalent ions may be provided employing an overcoating method. In the former case in which the compounds comprising multivalent metal ions are added to the ink absorptive layer forming liquid coating compositions, it is possible to use a method in which the aforesaid compounds are uniformly dissolved in water or organic solvents or solvent mixtures thereof, and subsequently added, or a method in which the aforesaid compounds are dispersed into minute particles employing a wet process crusher such as a sand mill or an emulsion dispersion method. When the ink receptive layer is comprised of a plurality of layers, the aforesaid compounds may be incorporated into coating composition(s) on only one layer, on least two layers, or on all layers. In the latter case in which after forming the porous ink receptive layer, the aforesaid compounds are added employing an overcoating method, it is preferable that compounds comprising multivalent metal ions are uniformly dissolving in solvents, and are then applied onto an ink receptive layer.

These multivalent metal ions are employed in an amount ranging from about 0.05 to 20 millimol per m² of the recording sheet and preferably from 0.1 to 10 millimol.

In the ink-jet recording sheet of the present invention, it is preferable to add hardeners which harden hydrophilic polymers forming the porous ink receptive layer.

Hardeners usable in the present invention are not particularly limited as long as they undergo hardening reaction with hydrophilic polymers. Boric acids and salts thereof are preferably employed. However, it is possible to use other prior art hardeners. Generally, hardeners include compounds having a group capable of reacting with hydrophilic polymers, or compounds which promote reaction between different groups of hydrophilic polymers, and are suitably selected and used depending on the types of hydrophilic polymers. Specific examples of hardeners include epoxy based hardeners (diglycidyl ethyl ether, ethylene glycol diglycidyl ether, 1,4-butanediol diglycidyl ether, 1,6-diglycidylcyclohexane, N,N-diglycidyl-4-glycidyloxyaniline, sorbitol polyglycidyl ether, and glycerol polyglycidyl ether), aldehyde based hardeners (formaldehyde and glyoxal), active halogen based hardeners (2,4-dichloro-4-hydroxy-1,3,5-s-triazine, bisvinyl sulfonylmethyl ether), and aluminum alum.

Boric acids or salts thereof refer to oxygen acids having a boron atom as the central atom and salts thereof, and specifically include orthoboric acid, diboric acid, metaboric acid, tetraboric acid, and pentaboric acid, octaboric acid and salts thereof.

Boric acids having a boron atom and salts thereof may employed in the form of an aqueous solution of individual one or a mixture of at least two types. An aqueous solution of a mixture of boric acid and borax is particularly preferred.

When boric acid and borax are individually used to prepare an aqueous solution, only a low concentration solution is prepared. However, when both are simultaneously dissolved in water, it is possible to prepare a solution of high concentration. As a result, it is possible to prepare concentrated liquid coating compositions. Further, a resulting advantage is that it is possible to relatively freely control the pH of the aqueous solution to be added. The total used amount of the aforesaid hardeners is preferably 1-600 mg per g of the aforesaid hydrophilic polymers.

Suitably employed as supports employed in the present invention are those known in the prior art as conventional ink-jet recording sheets. They may be water absorptive supports, but are preferably non-water absorptive.

Listed as water absorptive supports usable in the present invention may be, for example, common paper, fabrics, and sheets or plates comprised of wood. Employed as paper supports may be those prepared by using, as a main raw material, chemical pulp such as LBKP and NBKP, mechanical pulp such as GP, CGP, RMP, TMP, CTMP, VMP, or PGW, and wood pulp such as waste paper pulp including DIP. In addition, if desired, it is possible to suitably use synthetic pulp and various fibrous materials such as synthetic fiber or inorganic fiber.

If desired, it is possible to incorporate into the aforesaid paper supports various conventional prior art additives such as sizing agents, pigments, paper strength enhancing agents, fixing agents, optical brightening agents, wet paper strength enhancing agents, or cationizing agents.

Paper supports are prepared using a mixture of fiber materials with various additives while employing any of the various paper making machines such as a Fourdrinier paper machine, a cylinder paper machine, or a twin wire paper machine. Further, if desired, size press treatments using starch or polyvinyl alcohol are conducted during paper making stage or employing a paper making machine, and various coating treatments as well as calender finishing may be carried out.

Non-water absorptive supports which are preferably usable in the present invention are either transparent supports or opaque supports. Listed as transparent supports are films comprised of materials such as polyester based resins, diacetate based resins, triacetate based resins, acryl based resins, polycarbonate based resins, polyvinyl chloride based resins, polyimide based resins, cellophane, and celluloid. When used for OHP, those which exhibit radiation heat resistance are preferred, and polyethylene terephthalate is particularly preferred. The thickness of such transparent supports is preferably 50-200 μm.

Further, preferred as opaque supports are, for example, resin coated paper (so-called RC paper) which comprises a base paper having thereon a polyolefin resin layer containing white pigments on one side, and so-called white PET which is prepared by incorporating white pigments such as barium sulfate into polyethylene terephthalate.

For the purpose of enhancing adhesion between each of the aforesaid various supports and the ink absorptive layer, prior to coating of the ink absorptive layer, it is preferable that supports are subjected to a corona discharge treatment or a subbing treatment. Further, the ink-jet recording sheet of the present invention need not always be colorless, but may be tinted.

It is particularly preferable that employed as the ink-jet recording sheets of the present invention are paper supports prepared by laminating both sides of a base paper with polyethylene, since recorded images exhibit quality comparable to conventional photography and these high quality images are produced at low cost.

Such paper supports, which are laminated with polyethylene, will now be described.

Base paper employed for paper supports is produced employing wood pulp as a main raw material, and if desired, employing synthetic pulp such as polypropylene, or synthetic fiber such as nylon or polyester. As wood pulp, for example, any of LBKP, LBSP, NBKP, NBSP, LDP, NDP, LUKP, and NUKP may be employed. However, LBKP, NBSP, LBSP, NDP, and LDP having shorter fibers are preferably employed in a larger proportion. However, the content proportion of LBSP or LDP is preferably from 10 to 70 percent by weight.

Preferably employed as the aforesaid pulp is chemical pulp (sulfate pulp and sulfite pulp) with minimal impurities, and pulp is also useful of which whiteness is enhanced by bleaching treatments.

It is possible to suitably incorporate into base paper sizing agents such as higher fatty acids or alkylketne diners, white pigments such as calcium carbonate, talc, or titanium oxide, paper strength enhancing agents such as starch, polyacrylamide, or polyvinyl alcohol, optical brightening agents, humectants such as polyethylene glycol, dispersing agents, and softening agents such as quaternary ammonium.

The freeness of pulp used for paper making is preferably 200-500 ml under the specification of CSF, while in fiber length after beating, the sum of weight percent of 24 mesh residue and weight percent of 42 mesh residue, which are specified in JIS P 8207, is preferably 30-70 percent. Incidentally, weight percent of 4 mesh residue is preferably 20 weight percent or less. The basic weight of base paper is preferably 30-250 g, and is more preferably 50-200 g, while the thickness of the base paper is preferably 40-250 μm. Base paper may be resulted in high smoothness employing calender finishing during or after paper making. The density of base paper is customarily 0.7-1.2 g/cm³ (JIS P 8118). Further, the stiffness is preferably 20-200 g under conditions specified by JIS P 8143. Surface sizing agents may be applied onto the surface of base paper. Employed as surface sizing agents may be the same ones as those which can be incorporated into base paper. The pH of base paper, when determined by the hot water extraction method specified in JIS P 8113, is preferably 5-9.

Polyethylene which is employed to cover the obverse and rear surface of base paper is mainly comprised of low density polyethylene (LDPE) and/or high density polyethylene (HDPE). However, it is possible to partly use LLDPE and polypropylene.

It is preferable that opacity and whiteness of the polyethylene layer on the porous ink receptive layer side are improved by incorporation of anatase type titanium dioxide into polyethylene, as is widely employed in photographic paper. The proportion of titanium oxide is customarily 3 -20 percent by weight with respect to polyethylene, and is preferably 4-13 percent by weight.

In the present invention, polyethylene coated paper is employed as a glossy paper. Further, it is possible to use polyethylene coated of matte or silk surfaced paper, which is prepared as follows. When polyethylene is coated onto the surface of base paper employing melt extrusion, a matte surface or silk surface is formed on common photographic paper is formed employing embossing treatments. In the aforesaid polyethylene coated paper, it is particularly preferred to maintain the moisture content ratio in paper at 3-10 percent by weight.

In addition to constituting components described as above, it is possible to incorporate various types of additives known in the art into the ink-jet recording sheet of the present invention. For example, incorporated may be various types of additives, known in the art, which include minute organic latex particles comprised of polystyrene, polyacrylic acid esters, polymethacrylic acid esters, polyacrylamides, polyethylene, polypropylene, polyvinyl chloride, polyvinylidene chloride, or copolymers thereof, urea resins, or melamine resins; cationic surface active agents; UV absorbers described in JP-A Nos. 57-74193, 57-87988, and 62-261476; anti-discoloring agents described in JP-A Nos. 57-74192, 57-87989, 60-72785, 61-146591, 1-95091, and 3-13376; optical brightening agents described in JP-A Nos. 59-42993, 59-52689, 62-280069, 61-242871, and 4-219266; pH regulators such as sulfuric acid, phosphoric acid, citric acid, sodium hydroxide, potassium hydroxide, or potassium carbonate; and other agents such as defoamers, thickeners, antistatic agents, or matting agents.

The production method of the ink-jet recording sheet of the present invention will now be described.

As a production method of ink-jet recording sheets, it is possible to carry out production in such a manner that each of the constituting layers, including a porous ink receptive layer, is individually or simultaneously applied onto a support and subsequently dried employing a method which is suitably selected from prior art coating systems. Preferably employed as coating systems are, for example, a roll coating method, a rod bar coating method, an air knife coating method, a spray coating method, a curtain coating method, and a slide bead coating method as well as an extrusion coating method described in U.S. Pat. Nos. 2,761,419 and 2,761,791.

When simultaneous multilayer coating is carried out, viscosity of each liquid coating composition is preferably in the range of 5-100 mPa·s, and is more preferably in the range of 10-50 mPa·s in the case of the slide bead coating system. When the curtain coating system is employed, the aforesaid viscosity is preferably in the range of 5-1,200 mPa·s, and is more preferably in the range of 25-500 mPa·s.

Further, viscosity of liquid coating compositions is preferably 100 mPa·s or more at 15° C., is more preferably 100-30,000 mPa·s, is still more preferably 3,000-30,000 mPa·s, and is most preferably 10,000-30,000 mPa·s.

A coating and drying method will be described. Each of the liquid coating compositions is heated to 30° C. or more. After carrying out simultaneous multilayer coating, the resulting coating is temporarily chilled to 1-15° C. and subsequently dried at 10° C. or more. More preferred drying is carried out under drying conditions of a wet-bulb temperature in the range of 5-50° C. and a layer surface temperature in the range of 10-50° C. Further, from the viewpoint of forming a uniform coating layer, it is preferable that a horizontal set system is employed as a chilling system immediately after coating.

Further, it is preferable that the aforesaid production processes include a process to store the resulting coating a temperature between 35 and 70° C. for 24 hours-60 days.

Storage conditions are not particularly limited as long as they are between 35 and 70° C. for 24 hours-60 days. Preferred examples are 3 days—4 weeks at 36° C., 2 days-2 weeks at 40° C., or 1-7 days at 55° C. By practicing such heating treatments, it is possible to promote curing reaction or crystallization of hydrophilic polymers, whereby it is possible to achieve desired ink absorbability.

### EXAMPLES

The present invention will now be described with reference to examples. However, the present invention is not limited thereto. “%” in the examples is weight percent unless otherwise noted.

### Example 1

<<Preparation and Stability Evaluation of Oil Dispersions A-1-A-14>>

Oil Dispersions A-1-A-14 were prepared in such a manner that 400 g of polybutadienes (B-1000, manufactured by Nippon Soda Co., Ltd.) was mixed with each of the surface active agents and hydrophilic polymers described in Table 1, the resulting mixture was dispersed employing a high pressure homogenizer, and the total volume was adjusted to 1 L (40% effective component of the oil-soluble compound) by adding pure water.

Each of the resulting dispersions was sealed in a glass tube and left standing at 4020 C. for 24 hours. Thereafter, the dispersion state was visually observed and the stability of each dispersion was evaluated.

Each abbreviation described in Table 1 is detailed below.

*1: Emulgen 105 (HLB 9.7, manufactured by Kao Corp.)

*2: Emulgen 103 (HLB 8.1, manufactured by Kao Corp.)

*3: Emulgen 306P (HLB 9.4, manufactured by Kao Corp.)

*4: Emulgen 404 (HLB 8.8, manufactured by Kao Corp.)

*5: Emulgen 408 (HLB 10.0, manufactured by Kao Corp.)

*6: Emulgen 109P (HLB 13.6, manufactured by Kao Corp.)

*7: Emulgen 123P (HLB 16.9, manufactured by Kao Corp.)

*8: Emulgen 409P (HLB 12.0, manufactured by Kao Corp.)

*A: polyvinyl alcohol (PVA203, manufactured by Kuraray Co., Ltd.)

*B: polyvinyl alcohol (PVA235, manufactured by Kuraray Co., Ltd.)

*C: acid process gelatin

Table 1 shows the results.

TABLE 1

| | Surface Active | | | Surface Active | | | | | | |
|---|---|---|---|---|---|---|---|---|---|---|
| | Agent of HLB ≦ 10 | | | Agent of HLB > 10 | | | Hydrophilic Binder | | | |
| Oil | | | Added | | | Added | | Added Amount of | | |
| Dispersion | | HLB | Amount | | HLB | Amount | | 10% Aqueous | Dispersion | |
| No. | Type | Value | (g) | Type | Value | (g) | Type | Solution (g) | Stability | Remarks |
| A-1 | *1 | 9.7 | 2.0 | — | — | — | — | — | **1 | Comp. |
| A-2 | — | — | — | *6 | 13.6 | 2.0 | — | — | **2 | Comp. |
| A-3 | *1 | 9.7 | 2.0 | — | — | — | *A | 450 | **3 | Comp. |
| A-4 | — | — | — | *6 | 13.6 | 2.0 | *A | 450 | **4 | Comp. |
| A-5 | *1 | 9.7 | 1.0 | *6 | 13.6 | 1.0 | — | — | **5 | Inv. |
| A-6 | *2 | 8.1 | 1.0 | *6 | 13.6 | 1.0 | — | — | **5 | Inv. |
| A-7 | *3 | 9.4 | 1.0 | *6 | 13.6 | 1.0 | — | — | **5 | Inv. |
| A-8 | *4 | 8.8 | 1.0 | *6 | 13.6 | 1.0 | — | — | **5 | Inv. |
| A-9 | *5 | 10.0 | 1.0 | *6 | 13.6 | 1.0 | — | — | **5 | Inv. |
| A-10 | *1 | 9.7 | 1.0 | *6 | 13.6 | 1.0 | *A | 450 | **5 | Inv. |
| A-11 | *1 | 9.7 | 1.0 | *6 | 13.6 | 1.0 | *B | 400 | **5 | Inv. |
| A-12 | *1 | 9.7 | 0.8 | *7 | 16.9 | 1.2 | *A | 450 | **5 | Inv. |
| A-13 | *2 | 8.1 | 0.5 | *8 | 12.0 | 1.5 | *A | 450 | **5 | Inv. |
| A-14 | *2 | 8.1 | 0.5 | *8 | 12.0 | 1.5 | *C | 450 | **5 | Inv. |

**1; Dispersion was impossible
**2; Oil was separated after one hour
**3; Oil was separated after 5 hours
**4; Oil was separated after 12 hours
**5; Dispersion was well stabilized
Comp.; Comparative Example
Inv.; Present Invention

As can clearly be seen from Table 1, each of the dispersions constituted according to the present invention exhibited excellent dispersion stability even when dispersed at high concentration and each was highly commercially viable.

### Example 2

<<Preparation of Recording Sheets 1-9>>

(Preparation of Silica Dispersion D-1)

While stirring at 3,000 rpm at room temperature, 400 L of Silica Dispersion B-1 (exhibiting a pH of 2.5 and containing 0.5% ethanol) containing 25% uniformly dispersed vapor phase method silica (Aerosil 300, manufacture by Nippon Aerosil Co., Ltd.) of an average diameter of the primary particle of 0.007 μm was added to 110 L of Aqueous Solution C-1 (exhibiting a pH of 2.5 and containing 2 g of Defoamer SN-381, manufactured by Sun Nobco Ltd.) containing 12% Cationic Polymer P-1, 10% n-propanol, and 2% ethanol. Subsequently, while stirring, 54 L of Aqueous Mixture Solution A-1 of boric acid and borax at a ratio of 1:1 (having a concentration of 3% for each) was gradually added.

Subsequently, the resulting mixture was dispersed at 3 kN/cm², employing a high pressure homogenizer manufactured by Sanwa Industry Co., Ltd., and the total volume was adjusted to 630 L by adding pure water, whereby nearly transparent Silica Dispersion D-1 was prepared.

(Preparation of Silica Dispersion D-2)

While stirring at 3,000 rpm at room temperature, 400 L of aforesaid Silica Dispersion B-1 was added to 120 L of Aqueous Solution C-2 (at a pH of 2.5) containing 12% Cationic Polymer P-2, 10% n-propanol, and 2% ethanol. Subsequently, the resulting mixture was dispersed at 3 kN/cm², employing a high pressure homogenizer, manufactured by Sanwa Industry Co., Ltd., and the total volume was adjusted to 630 L by adding pure water, whereby nearly transparent Silica Dispersion D-2 was prepared.

Each of aforesaid Silica Dispersions D-1 and D-2 was filtered employing a TCP-30 Type Filter at a filtration accuracy of 30 μm, manufactured by Advantech Toyo Co., Ltd.

Cationic Polymer P-1

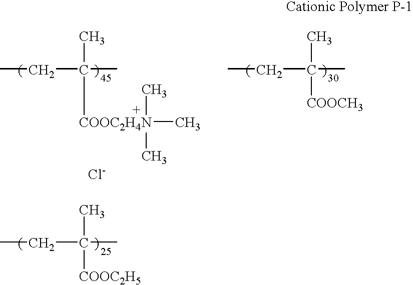

Cationic Polymer P-2

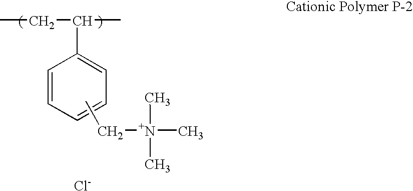

(Preparation of Ink Receptive Layer Liquid Coating Composition)

Each of the additives described below was successively added to each of the oil dispersions prepared in Example 1 and the aforesaid silica dispersion, whereby each ink receptive layer liquid coating composition was prepared. Incidentally, each of the added amounts was the amount per liter.

(First Layer Liquid Coating Composition: Lowermost Layer)

(First Layer Liquid Coating Composition: Lowermost Layer)

| | | |
|---|---|---|
| Silica Dispersion D-1 | 580 | ml |
| 10% aqueous polyvinyl alcohol (PVA203, | 5 | ml |
| manufactured by Kuraray Co., Ltd.) | | |
| solution | | |
| 6.5% aqueous polyvinyl alcohol (at an | 290 | ml |
| average degree of polymerization | | |
| of 3,800 and a saponification | | |
| ratio of 88%) solution | | |
| Oil Dispersion A-2 | 30 | ml |
| 4% aqueous surface active agent | 2.0 | ml |
| (Ftergent 400S, manufactured | | |
| by Neos Co.) | | |
| Pure water to make | 1000 | ml |

(Second Layer Liquid Coating Composition)

| | | |
|---|---|---|
| Silica Dispersion D-1 | 580 | ml |
| 10% aqueous polyvinyl alcohol (PVA203, | 5 | ml |
| manufactured by Kuraray Co., Ltd.) | | |
| solution | | |
| 6.5% aqueous polyvinyl alcohol (at an | 270 | ml |
| average degree of polymerization | | |
| of 3,800 and a saponification | | |
| ratio of 88%) solution | | |
| Oil Dispersion A-2 | 20 | ml |
| Pure water to make | 1000 | ml |

Third Layer Liquid Coating Composition

| | | |
|---|---|---|
| Silica Dispersion D-2 | 630 | ml |
| 10% aqueous polyvinyl alcohol (PVA203, | 5 | ml |
| manufactured by Kuraray Co., Ltd.) | | |
| solution | | |
| 6.5% aqueous polyvinyl alcohol (at an | 270 | ml |
| average degree of polymerization | | |
| of 3,800 and a saponification | | |
| ratio of 88%) solution | | |
| Oil Dispersion A-2 | 15 | ml |
| Pure water to make | 1000 | ml |

(Fourth Layer Liquid Coating Composition: Uppermost Layer)

| | | |
|---|---|---|
| Silica Dispersion D-2 | 660 | ml |
| 10% aqueous polyvinyl alcohol (PVA203, | 5 | ml |
| manufactured by Kuraray Co., Ltd.) | | |
| solution | | |
| 6.5% aqueous polyvinyl alcohol (at an | 250 | ml |
| average degree of polymerization | | |
| of 3,800 and a saponification | | |
| ratio of 88%) solution | | |
| 25% aqueous saponin solution | 2 | ml |
| 4% aqueous surface active agent | 9.0 | ml |
| (Futergent 400S, manufactured | | |
| by Neos Co.) | | |
| Pure water to make | 1000 | ml |

Each of the liquid coating compositions, prepared as above, was filtered employing a TCPD-30 Filter of a filtration accuracy of 20 μm, manufactured by Advantech Toyo Co., Ltd. and subsequently filtered employing a TCPD-10 Filter.

(Preparation of Recording Sheet)

Subsequently, the aforesaid four liquid coating compositions were simultaneously applied onto a paper support (RC paper) which had been coated with polyethylene on both sides to result in the wet layer thickness described below, employing a slide hopper type coater.

<Wet Layer Thickness>

First Layer : 42 μm

Second Layer: 39 μm

Third Layer: 44 μm

Fourth Layer: 38 μm

Incidentally, the width and length of the aforesaid RC paper, employed as a support, were approximately 1.5 m and approximately 4,000 m, respectively, which was wound on a roll. The RC paper was prepared as described below.

The employed RC paper was prepared as follows. Polyethylene, containing 6 percent anatase type titanium oxide, was melt-extruded onto the front surface of basic weight 170 g photographic base paper to result in a thickness of 35 μm, and polyethylene at a thickness of 40 μm was melt-extruded onto the back surface. The front side was subjected to corona discharge and subsequently polyvinyl alcohol (PVA235, manufactured by Kuraray Co., Ltd.) was applied to result in a coated weight of 0.05 g per m² of the recording media to form a sublayer. The reverse side was also subjected to corona discharge, and subsequently, a backing layer was applied which was comprised of approximately 0.4 g of a styrene-acrylic acid ester based latex binder at a Tg of approximately 80° C., 0.1 g of an antistatic agent (being a cationic polymer) and 0.1 g of approximately 2 μm silica as a matting agent.

Drying after coating the ink receptive layer liquid coating composition was carried out in such a manner that the layer surface temperature was decreased to 13° C. by allowing the coating to pass through a 5° C. chilling zone at, and subsequently, drying was carried out through a plurality of drying zones in which each temperature was suitably set. After drying, the resulting coating was wound in a roll, whereby Recording Sheet 1 was prepared.

Subsequently, Recording Sheets 2-9 were prepared in the same manner as the preparation of aforesaid Recording Sheet 1, except that Oil Dispersion A-2 was replaced with each of Oil Dispersions A-3-A-5 and A-10-A-14 prepared in Example 1.

<<Preparation of Recording Sheet 10>>

Recording Sheet 10 was prepared in the same manner as aforesaid Recording Sheet 1, except that the oil dispersion was not added to the first layer, second, and third layer liquid coating compositions.

<<Preparation of Recording Sheet 11>>

Recording Sheet 11 was prepared in the same manner as aforesaid Recording Sheet 1, except that an ethyl acetate solution of polybutadiene (B-1000, manufacture by Nippon Soda Co., Ltd.) was added to the first, second, and third layer liquid coating compositions, instead of Oil Dispersion A-2, to result in the same-coating weight.

<<Preparation of Recording Sheet 12>>

Recording Sheet 12 was prepared in the same manner as Recording Sheet 5, except that 2-n-octyl-4-isothiazoline-3-one and polyhexamethylene guanidine hydrochloric acid salt were added to Oil Dispersion A-10.

<<Preparation of Recording Sheet 13>>

Recording Sheet 13 was prepared in the same manner as Recording Sheet 5, except that a solution prepared by diluting Zircozol ZA (an aqueous zirconyl acetate solution, manufactured by Daiichi Kigenso Kagaku Kogyo Co., Ltd.) with pure water was uniformly applied employing spray coating to result in a coating weight of zirconyl acetate of 0.5 g/m², and subsequently dried.

<<Evaluation of Recording Sheets>>

Recording Sheets 1-13, prepared as above, were subjected to evaluation of each characteristic below.

(Evaluation of Oxidizing Gas Resistance)

Employing Ink-jet Printer BJ-F870, manufactured by Canon Inc., solid cyan images were recorded on each of the recording sheets prepared as above and left standing in a 2 ppm ozone ambience for 24 hours. Thereafter, the oxidizing gas resistance of the solid cyan images was evaluated. The oxidizing gas resistance was expressed by the residual ratio of the initial solid image density. The larger the value, the better the oxidizing gas resistance.

(Evaluation of Bleeding Resistance)

Employing Ink-jet Printer PM900C, manufactured by Seiko Epson Corp., approximately 0.3 mm wide black lines were printed on a solid red image print and then stored at 50° C. and relative humidity of 85 percent for three days. The line width was measured prior to and after storage, employing a microdensitometer (the width of a portion which exhibited 50 percent of the maximum reflection density was designated as line width), and a bleeding ratio (line width after storage/line width prior to storage) was determined and used as a scale for bleeding resistance.

(Evaluation of Non-Uniformity Resistance)

Solid green images were printed on each recording sheet, employing Ink-jet Printer BJ-F870, manufactured by Canon Inc., and the uniformity of the resulting images was visually evaluated. Non-uniformity resistance was evaluated based on the criteria described below.

A: uniform solid images were noted

B: solid images looked uniform at a viewing distance of at least 30 cm

C: solid images looked uniform at a viewing distance of at least 60 cm

D: solid images looked non-uniform at 60 cm or more

(Evaluation of Cracking)

The cracking state of area of 0.1 m² on the coating surface of each recording sheet was visually observed employing a portable magnifying glass and cracking resistance was evaluated based on the criteria below.

(Evaluation of Cracking Resistance)

A: cracks were hardly noted

B: several microscopic cracks of less than 0.5 mm were noted

C: several large cracks of at least 0.5 mm were noted

D: large cracks of at least 0.5 mm were noted over the entire surface

Table 2 shows the results.

TABLE 2

| | | Each Evaluation Result | | | | |
|---|---|---|---|---|---|---|
| Re- | Oil | | Bleed- | Non- | | |
| cording | Dis- | Oxidizing | ing | Uni- | | |
| Sheet | persion | Gas | Resis- | formity | Cracking | Re- |
| No. | No. | Resistance | tance | Resistance | Resistance | marks |
| 1 | A-2 | 75% | 1.10 | D | D | Comp. |
| 2 | A-3 | 80% | 1.08 | C | D | Comp. |
| 3 | A-4 | 82% | 1.05 | C | C | Comp. |
| 4 | A-5 | 95% | 1.03 | A | B | Inv. |
| 5 | A-10 | 95% | 1.04 | A | B | Inv. |
| 6 | A-11 | 98% | 1.03 | A | A | Inv. |
| 7 | A-12 | 96% | 1.03 | A | B | Inv. |
| 8 | A-13 | 95% | 1.04 | A | B | Inv. |
| 9 | A-14 | 94% | 1.04 | B | B | Inv. |
| 10 | A-2 | 55% | 1.05 | A | A | Comp. |
| 11 | — | 85% | 1.08 | C | C | Comp. |
| 12 | A-10 | 95% | 1.03 | C | B | Inv. |
| 13 | A-10 | 95% | 1.01 | A | B | Inv. |

Comp.; Comparative Example
Inv.; Present Invention

As can clearly be seen from Table 2, Recording Sheets (4-9, 12, and 13) which were constituted as specified by the present invention exhibited excellent resistance to all of oxidizing gas, bleeding, non-uniformity, and cracking and were capable of comprehensively forming high quality images, compared to the recording sheets in Comparative Examples. Further, it was noted that the glossiness of Recording Sheets 1-3 as well as 10 was degraded due to formation of aggregates of oil components.

In accordance with the present invention, it is possible to provide an ink-jet recording sheet which exhibits excellent resistance to oxidizing gas, bleeding, non-uniformity, and cracking by incorporating, into an ink receptive layer, an oil-soluble compound dispersion which exhibits excellent stability.

What is claimed is:

1. An ink-jet recording sheet comprising a support having thereon a porous ink receptive layer containing a dispersion of an oil-soluble compound,
wherein the dispersion is prepared by dispersing the oil-soluble compound with at least two nonionic surface active agents differing in HLB value.

2. The ink-jet recording sheet of claim 1, wherein the dispersion further contains a hydrophilic polymer.

3. The ink-jet recording sheet of claim 1, wherein one of the two nonionic surface active agents has a HLB value of not more than 10, and the other one has a HLB value of more than 10.

4. The ink-jet recording sheet of claim 1, wherein the oil-soluble compound contains a plurality of non-aromatic unsaturated carbon-carbon bonds in the molecule.

5. The ink-jet recording sheet of claim 4, wherein the oil-soluble compound is a polymer derived from a butadiene monomer.

6. The ink-jet recording sheet of claim 1, wherein the dispersion further contains an antiseptic agent.

7. The ink-jet recording sheet of claim 1, wherein the porous ink receptive layer further contains inorganic micro particles and a hydrophilic polymer.

8. The ink-jet recording sheet of claim 1, wherein the porous ink receptive layer further contains a cationic polymer.

9. The ink-jet recording sheet of claim 1, wherein the porous ink receptive layer further contains a water-soluble multivalent metal compound.
